(19) United States
(12) Patent Application Publication
(10) Pub. No.: US 2016/0371324 A1
(43) Pub. Date: Dec. 22, 2016

(54) SYSTEM FOR OBSERVING AND ANALYZING CONFIGURATIONS USING DYNAMIC TAGS AND QUERIES

(71) Applicant: INFRASIGHT LABS AB, Malmo (SE)

(72) Inventors: Konrad Eriksson, Arlov (SE); Magnus ANDERSSON, Lomma (SE)

(73) Assignee: INFRASIGHT LABS AB, Malmo (SE)

(21) Appl. No.: 15/253,719

(22) Filed: Aug. 31, 2016

Related U.S. Application Data
(63) Continuation of application No. 14/119,456, filed on Nov. 22, 2013.
(60) Provisional application No. 61/490,868, filed on May 27, 2011.

(51) Int. Cl. G06F 17/30; G06F 9/455; H04L 12/24

(52) U.S. Cl. CPC G06F 17/30377; G06F 17/30598; G06F 17/30864; G06F 17/30554; H04L 41/0866; G06F 9/45558; G06F 2009/45595

(57) ABSTRACT

There is provided a system for tagging information in a virtual server environment based on a systems model. The system comprises a systems model arranged to provide configuration data for tags. The tags are associated with configurable items of the systems model in the virtual server environment. The system further comprises an evaluation rules engine arranged to evaluate data in the virtual server environment based on a set of predetermined evaluation rules and the provided configuration data, and to generate a new tag, remove an existing tag, or update an existing tag based on the evaluation.

### TECHNICAL FIELD

The present invention relates to a virtual server environment. Particularly there is provided a computerized method, a system and a computer program product for tagging information in a virtual server environment based on a systems model of a managed system.

### BACKGROUND

System configurations are complex and requirements related to these systems vary considerably. Requirements can include (but not limited to) reliability, security and compliance.

Configurations contain many items where multiple parameters can change over time. These items are usually called ‘Configurable Items’ (CI). These Configurable Items may be inter-related. Either by depending on each other or by affecting each other due to the structure and/or setup of the system covered.

System administrators may typically want to understand the status of the whole system, apply prior gained knowledge how parts of the system relate and behaves to increase the understanding of the status, fast find relevant information in a potential large status set, and draw conclusions of the status on how well various reliability, security and performance criteria are met.

System management products often use a data model to represent the actual systems. This is often referred to as a Configuration Management Database (CMDB). Discovery systems obtain configuration data and translate it into this model in form of Configurable Items (CI). Relations and dependencies between CIs are expressed with associations between the CIs in the model. Re-discovery can be run periodically or on-demand to put fresh configuration data into the model.

CIs can be hard to identify for an administrator since the discovery might label CIs with non-intuitive names and/or relations to other CIs. It could be difficult to relate the technical state towards an external contextual meaning, like e.g. a business function or a department. Automatic discovery might also result in a data model, which does not sufficiently represent the actual state. One example is when an appliance is discovered and identified as being something that it is not (e.g. a switch being identified as a printer). Another example is when an automatic discovery results in incomplete information.

In addition, before making use of the results, an administrator must add manual changes to the model in order to correct faulty information or in order to add missing information.

The additional manual changes must be applied to the model (possibly after every re-discovery in a CMDB) or kept in separate documentation. Examples of such manual systems are spreadsheets (e.g. as an Excel document) word processing documents (e.g. as a Word document) or drawing applications (e.g. as a Visio document) or documentation portals (e.g as a Sharepoint portal).

Prior gained knowledge that may help to understand the status is often kept in administrators' minds or in separate documentation that requires extra effort to be maintained to keep up to date and this prior gained knowledge is not taken into account when analyzing the configuration. This also makes it more difficult (for others) to quickly understand the system, which might result in a system becoming dependent on one or a few individuals.

To check and monitor the state of the configuration, management products validate configuration values against pre-setup static thresholds, such as the CPU utilization being smaller than 80%, the RAM utilization being smaller than 75%, etc. This does not take in account manually added information and/or contextual or business relations unless work is done to create separate threshold checks for individual systems by someone that know each particular systems function. This results in a large setup overhead that also adds extra maintenance work for each added new system.

This kind of checks and monitor procedures also becomes very complex when the number of CIs increases and then also configuration data rise above a certain size. What are relatively easily maintainable threshold checks for small environments quickly becomes an inter-tangled web of dependencies and relations to take in account when defining the checks.

### SUMMARY OF THE INVENTION

It is an object of the present invention to improve the current state of the art, to solve the above problems, and to provide an improved solution that helps system administrators to faster and more accurate assess the configuration status of multiple systems in a heterogeneous environment and which provides the possibility to combine automatically discovered configuration data with manually maintained contextual information.

When problems are found they could be mitigated by reconfiguration of the system. It has been discovered that this may be accomplished either by notifying an appropriate person monitoring the system to manually carry out the task, or by enabling the monitoring system to automatically reconfigure the affected system as a result of found policy breaches.

These and other objects are according to a first aspect achieved by a computerized method for tagging information in a virtual server environment based on a systems model of a managed system, comprising providing configuration data for tags, the tags being associated with configurable items of the systems model in the virtual server environment, evaluating data in the virtual server environment basket on a set of predetermined evaluation rules and the provided configuration data, and generating a new tag, removing an existing tag, or updating an existing tag based on the evaluation.

Additional operator knowledge can thus be added to the systems model in form of tags and thus be part of analysis of the managed system. Data correlation and derivation logic can be expressed in dynamic (i.e. computed) tag computations that simplifies understanding of the (systems model of the) managed system and also simplifies further data processing. This may result so more efficient program code and shortened development time. Further, complex data derivation can be expressed more easy by combining data from several tags (where the tags can represent results from previously data derivation steps in other dynamic tags) mixed with configuration data. A mix of manual and dynamic tags enables merging direct operator knowledge with induced results from dynamic tag computations.

Re-validation of criteria/policies can be automated and triggered by various changes in the configuration data and tags. Optionally an operator may review and take appropriate actions when being presented with the result of the evaluation. An operator can then manually insert tags to indicate certain knowledge that (optionally) can override computed tags.

The generating may be performed in response to receiving user input relating to meta-data of the tag.

Each tag may have a value, and the value may be derived from at least one from the group of configuration data, manually added tags, and/or computed tags.

The method may further comprising performing an action based on the tags and based on a set of predetermined action rules.

The method may further comprising updating the systems model based on the action.

The managed system may relate to at least one managed virtual and/or physical server, and the method may further comprising transmitting provisioning and/or modifications from the systems model to the managed system based on the updated systems model, thereby causing changes to the at least one managed virtual and/or physical server.

The step of evaluating may be triggered as a result of an event occurred in the managed system.

The step of evaluating may be continuously performed during operation of the systems model.

The configuration data may be received by the systems model from the managed system.

The method may further comprising executing at least one query, thereby finding items matching the configuration data and/or combinations of associated manual and dynamic tags. Thereby the dynamic tags may helps with abstracting and simplifying certain data derivation steps to enable queries to be specified on a more logical level. Evaluation of criteria/policies for system reliability, security and performance can be expressed as queries and their expected results. This enables translating high-level system validation criteria/policies into a set of queries and their expected results where they later can be run at any time to re-check the configuration. These evaluations can also be automatically run in response to any detected changes in the configuration.

Queries can help operators to find problems or deviations in an easily expressible way including matching on tags. Many checks of system reliability, security and performance criteria/policies can be automated by translating them into query evaluations.

The method may further comprising transmitting a result of the query to a user interface as a report and/or log. The result from these queries can be presented to user to aid in configuration analysis and locating abnormalities. Reports and logs can also be created from results from queries as well as inputs to other data gather/summarizing products.

The above objects are according to a second aspect achieved by a computer program product stored on a non-volatile storage medium and comprising software instructions that when executed on a processor causes the processor to perform a method according to the above.

The above objects are according to a third aspect achieved by a system for tagging information in a virtual server environment based on a systems model, comprising a systems model arranged to provide configuration date for tags, the tags being associated with configurable items of the systems model in the virtual server environment, an evaluation rules engine arranged to evaluate data in the virtual server environment based on a set of predetermined evaluation rules and the provided configuration data, and to generate a new tag, remove an existing tag, or update an existing tag based on the evaluation.

The system may further comprise an action rules engine arranged to perform an action based on the tags and based on a set of predetermined action rules.

In summary, the above objects may be achieved by computer implemented means implementing a system management loop, an evaluation loop end a remediation loop. In the system management loop; configuration data and other data from the managed systems is retrieved in order to populate the systems model that represents the actual state of the systems. Updates to the systems model (e.g. a cloned version called ‘desired state’) are transmitted beck onto the managed systems. In the evaluation loop data is fed to the evaluation rules engine. The evaluation rules engine generates and attaches tags to the systems model. In the remediation loop: tags are evaluated, and actions that are desirable to remediate potential problems are derived and performed on the systems model. In view of the above, tagging may thus be used as a core element of the systems model. Evaluation rules are executed on the system state (of the managed system), and may be stored in the systems model, and may produce new tags that are then attached to the systems model. Action rules evaluate the model and its tags and perform actions based on the tags.

The second and third aspects may generally have the same features and advantages as the first aspect and vice verse. Other objectives, features and advantages of the present invention will be apparent from the following detailed disclosure, from the attached dependant claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The above objects, as well as additional objects, features and advantages of the present invention, will be more fully appreciated by reference to the following illustrative and non-limiting detailed description of preferred embodiments of the present invention, when taken in conjunction with the accompanying drawings, wherein:

FIG. 1 is a block diagram illustrating how a Dynamic Tag fetches input and as result generates a new tag according to an embodiment;

FIG. 2 is a block diagram illustrating how computation of Dynamic Tags is related to a systems model and components of a Dynamic Tag according to an embodiment;

FIG. 3 is a block diagram illustrating input variables from a systems model as used by a Dynamic Tag computation according to an embodiment;

FIG. 4 is a block diagram illustrating how a query acts on a system model and the results thereof according to an embodiment;

FIG. 5 is a block diagram illustrating components of a evaluation criteria and how they act with a system model and each ether according to an embodiment;

FIG. 6 is a block diagram of a system according to an embodiment.

FIG. 7 is a flowchart of methods according to embodiments.

### DETAILED DESCRIPTION OF PREFERRED EMBODIMENTS OF THE INVENTION

The present invention will now be described more fully hereinafter with preference to the accompanying drawings, in which certain embodiments are shown. Like numbers refer to like elements throughout. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art.

Tagging of configuration items indicates that short and freely choosable strings (so-called tags) can be attached to any item in the data model. These tags can also contain a value along with the string, making them able to carry both a string identifier and an optional value, not limited to a specific format. All elements can be tagged with a sequence or set of tags. A view/display can be constrained to a subset of the tags.

Tags can further be divided into at least the following two categories:
a) Manual Tags: tags that are either manually added by an operator or by some other external actor.
b) Dynamic Tags: tags that are computed from a combination of configuration data and/or other tags.

### Manual Tags

Manual tags can be associated, that is semantically bound, to zero or more CIs. Adding of an association between a manual tag and a certain CI can be carried out via a user-interface, from prior created settings, imports or other interfaces and the target CI is matched based one or more if its properties. The association between a manual tag and a CI can be persistent, meaning that even if certain properties of the target CI changes the association is still valid. A tag association may be able to handle a re-discovery resulting in CIs being freshly inserted into the model and to re-establish the tag association for CIs that represent the same item as when the tag association was created.

### Dynamic Tags

A Dynamic Tag is a description and a computation that can be executed on any configuration item (CI) and thereby result in a new tag with a name, and optionally a value, associated with the target model object.

The computation decides whether or not the Dynamic Tag is going to output a new tag for a certain input object. The computation also outputs the name and value of the resulting new tag.

As seen in FIG. 2 the computation can take into account any data in the model, including CI attributes, associated tags, associated CIs and their attributes and tags, extending this to arbitrary model traversal depth. Also other values outside the model can be used in the computation, such as, but not limited to: time/date, user information and settings.

Since Dynamic Tags can take into account other tags, they can be stacked so that the output from one Dynamic Tag can be part of the input of another Dynamics Tag. This stacking occurs implicitly when a Dynamic Tag computation is specified to take into account tags that are results from other Dynamic Tag computations.

The computation of tags resulting from Dynamic Tags can either be computed in a) an iterative mode, or b) an on-demand mode.

The iterative mode means that in each iteration all Dynamic Tags are evaluated on all CIs and where resulting tags are outputted these are attached to the corresponding CI to be available as input when running the next iteration. A functional loop illustrating this process can be seen in FIG. 3. This process continues until no more new tags are generated during the iteration or a steady state is reached.

In the on-demand mode Dynamic Tags are evaluated on a specific CI when asked for. This can be triggered either by user request, displaying or by another Dynamic Tag using tags on certain CIs as input for its computation.

This “lazy” evaluation of Dynamic Tags can postpone and/or avoid carrying out certain computations if they are not directly needed or in-directly to save computing power and speed up the overall response time.

### Queries

A query retrieves data from the model following a certain matching and computation description. The data to be retrieve is often one or more configuration Items (CI) from the model that matches the query. Queries are not limited to output only CIs but can also output strings, numbers or other value-types gathered by the query.

The query can take into account CIs and their attributes, CIs associations and association ends as well as associated manual and dynamic tags.

### Criteria Evaluation

As noted above a query combined with its expected result can describe and evaluate a criterion that, for example, can come from policies regarding reliability, security and performance. Such policies can also be criteria from compliance standards documents or best practice.

By translating the criteria from these policies (often written in natural languages) onto query-result pairs, these pairs can be stored on the system and evaluated at any time to validate the model. Deviations from the expected can be handled by, but are not limited to: notifications to the operator via alarms and/or events, logging or automatically remediation by pre-defined actions. The handling of evaluation results can depend on an optional rating (examples: “normal”, “critical” . . . ) on the query-result pairs.

Re-evaluation of query-result pairs can be automatic triggered by changes in the configuration data, tags or any data related to evaluation of the criteria.

In summary, there has been disclosed a computerized method for tagging information in a virtual server environment based on a systems model of a managed system. The method comprises in a step S02 providing configuration data for tags, the tags being associated with configurable items off the systems model in the virtual server environment. The method comprises in a step S04 evaluating data in the virtual server environment based on a set of predetermined evaluation rules and the provided configuration data. The method comprises in a step S06 generating a new tag, removing an existing tag, or updating an existing tag based on the evaluation.

The method may in a step S08 further comprise performing an action based on the tags and based on a set of predetermined action rules. The systems model may in a step S10 be updated based on the action. The systems model may relate to at least one managed virtual and/or physical server. The method may therefore comprise in a step S12 transmitting provisioning and/or modifications from the systems model to the managed system based on the updated systems model, thereby causing changes to the at least one managed virtual and/or physical server.

According to embodiments the method further comprises in a step S14 executing at least one query, thereby finding items matching the configuration data and/or combinations of associated manual and dynamic tags. A result of the query may in a step S16 the transmitted to a user interface as a report and/or log.

A computer program product stored on a non-volatile storage medium may comprise software instructions that when executed on a processor causes the processor to perform the above disclosed acts.

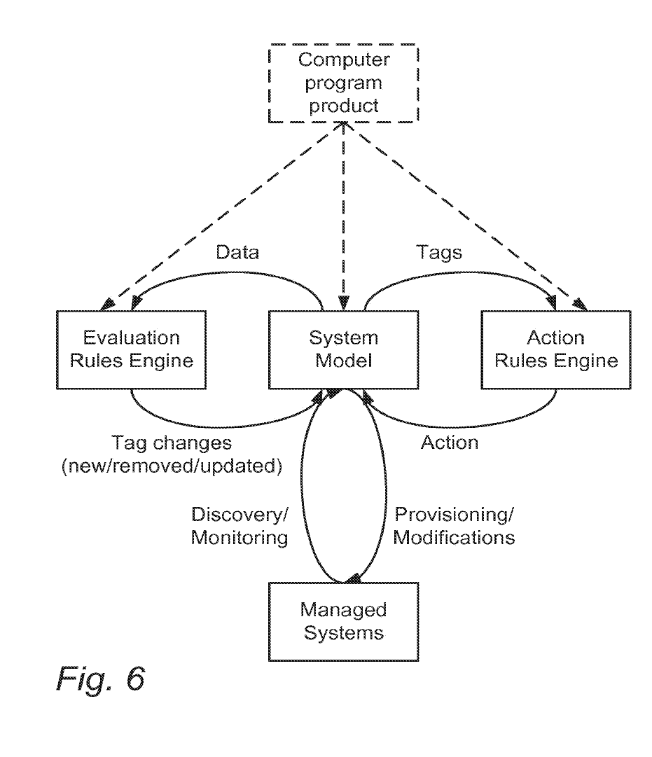

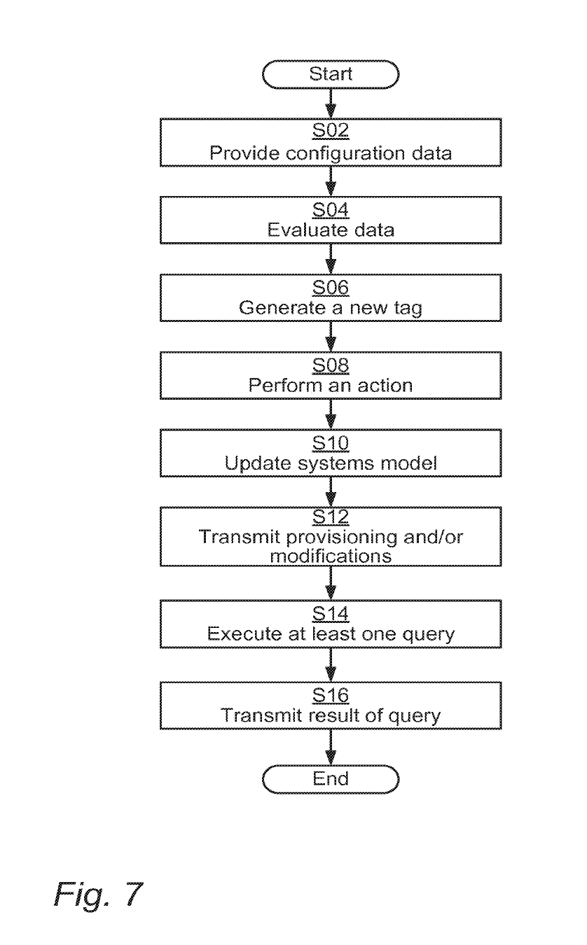

A system for tagging information in a virtual server environment based on a systems model may, as illustrated in FIG. 6, comprise a systems model arranged to provide configuration data for tags, the tags being associated with configurable items of the systems model in the virtual server environment, an evaluation rules engine arranged to evaluate data in the virtual server environment based on a set of predetermined evaluation rules and the provided configuration data, and to generate a new tag, remove an existing tag, or update an existing tag based on the evaluation.

According to embodiments the system further comprises an action rules engine arranged to perform an action based on the tags and based on a set of predetermined action rules

According to embodiments the managed system relates to at least one managed virtual and/or physical server. The systems model may then be further arranged to transmit provisioning and/or modifications to the managed system based on an updated systems model, and wherein the systems model thereby is arranged to cause changes to the at least one managed virtual and/or physical server.

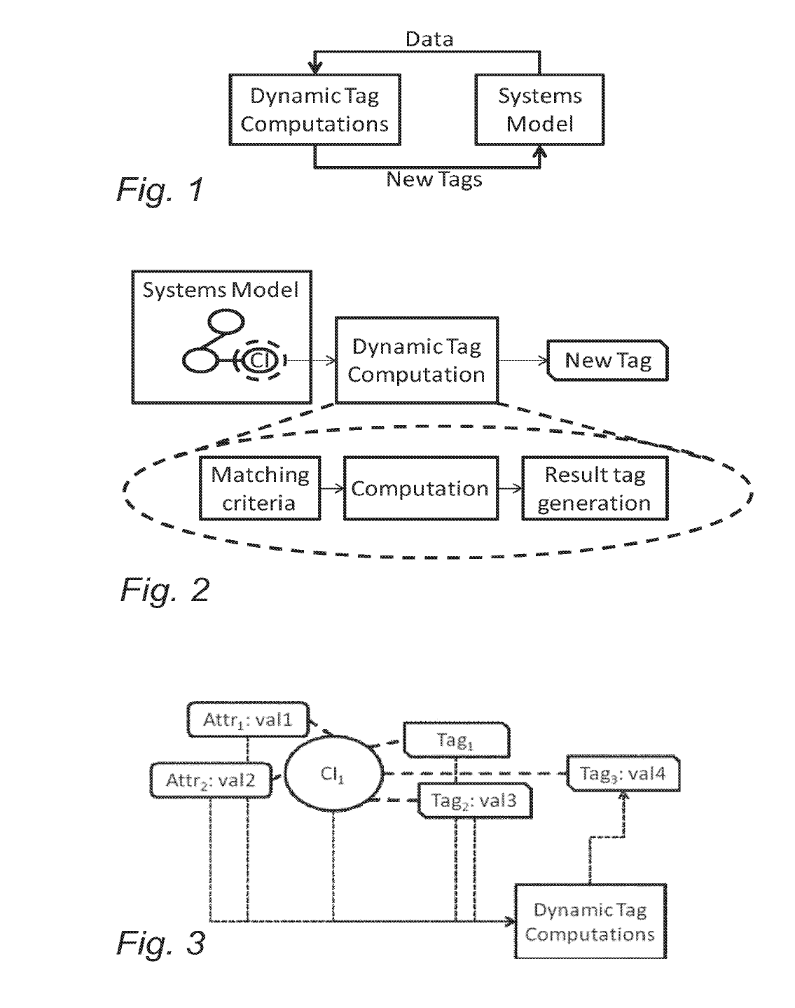

Next follows a number of typical scenarios as illustrated in FIGS. 1-6 in which the disclosed embodiments may be readily applied. However, the person skilled in the art realizes that the present invention by no means is limited to the preferred embodiments described herein. On the contrary, many modifications and variations are possible within the scope of the appended claims.

### Scenario 1

### Automated Classification of Resources Based on Dynamic Tags

According to this scenario CIs automatically get tagged with easily understandable context indicators based on classification rules described with Dynamic Tags.

Certain CI attributes and/or parts of their values can indicate important business or context logic and these mappings can be expressed in DynamicTags that generate tags that indicate the concerned logic and the context value. A DynamicTag is setup for each mapping that should be carried out and its matching criteria is defined to include CIs relevant for this mapping, see FIGS. 2 and 3. Matching criteria is specified the same way as for queries and some basic examples can be found in Scenario 3.

Examples of systems model specific matching criteria are:
a) With a certain IP-Address
b) In a certain IP-address range
c) With a specific name or letters in the name
d) Associated with a certain location CI or host system CI
e) Using storage from a certain storage system
f) Having any association with certain network CIs

The output from the DynamicTag is then defined as a tag with the name indicating the logic it covers and the value being a context identifier or a static value (defined in the DynamicTag).

Examples of context logic are:
a) Inventory name of a system (Tag name: “Name”, value: “SERV12FIN”)
b) Owner/responsible for a system (Tag name: “Owner”, value: “Johan”)
c) Department/organizational unit a system resides in (Tag name: “Department”, value: “Finance”)
d) Service provided by a system (Tag name: “Service”, value: “WebServer”)
e) Cost associated with a system (Tag name: “Cost”, value: “150$/month”)
f) Storage used by a system (Tag name: “Storage”, value: “SAN”)
g) System reaches a certain network (Tag name: “Network A”, value: “reachable”)

Matching criteria and result calculation can be combined freely and are not limited to the above examples.

A classification example is a company that have a naming convention that all machines with a name ending with “FIN” is located in Finland. This example mapping can be realized with a DynamicTag with a matching criteria as follows: [Systems with name=*FIN] and result as tag [name=“Location”, value=“Finland”].

### Scenario 2

### Automatic Metrics and Value Calculations Using Dynamic Tags

According to this scenario there is described a system where tags are automatically generated with values being results of mathematical computations on model data to bring clarity in system states, summarize usage and resource utilization. This can be used to aggregate and calculate new values based in existing distributed values and relations in the model to enable faster overview of the overall state, highlight certain data areas or provide interim computation results to be used in further calculation steps.

When creating a DynamicTag for this purpose the matching criteria is indicative of which CIs the calculation should start from and the resulting tag is going to be associated with. Calculation carried out on the model can contain a mix of standard numeric algebra (add, subtract, multiply, divide, sum, . . . ) and complex user-defined steps also including following association to related CIs in the model, further tags and DynamicTag results. The resulting tag should have a name that indicates what the value concerns, and the result value can be of any type.

The actual calculations of the resulting tags from the DynamicTags can either be performed on-demand when requested or according to an iterative mode where all DynamicTags are calculated in an iterative fashion.

Examples of values and metrics are:
a) Count used space on all hard drives for a system
   Result tag on system; [name=“HDDs” value=2]
b) Calculate usage ratio of storage space
   Result tag on system: [name=“Used storage”, value=20%]
c) Count how many systems that use the same network switch
   Result tag on switch: [name=“System count”, value=8]
d) Count backups for each system
   Result tag on system: [name=“Backups” value=3]
e) Calculate total uptime/downtime for a system
   Result tag on system: [name=“Uptime” value=200]
f) Calculate cost for running a system depending on resource usage and/or allocation
   Result tag on system: [name=“Cost” value=120]
g) Count amount of resources on a system that is used by a certain department (derived also from manual tags)
   Result tag on system: [name=“Finance CPU Usage” value=20]

### Scenario 3

### Using Queries to Find Items of Interest

This scenario describes a system where queries are used to locate items in the model matching certain criterias. This can be used to locate CIs of interest using some date and/or characteristics related to the CIs.

### Examples of matching criteria are:

a) Match on arbitrary CI attribute and/or its value,
b) Match on associations in/out from a CI and their type/attributes.
c) Match on associated manual tags and Dynamic Tag results.
d) Use a, b and c on arbitrary model traversal depth following associations and other relations.
e) Match on values from outside the model or prompted to be input by user.

Several matching criteria can be combined is form a complex query. To obtain the result the query is executed on the systems model and returns zero or more CIs that matched the matching criteria specified in the query. The resulting CIs can be presented in a graphical representation of the systems model by highlighting or marking the items related to the query result. Filtering out matching or non-matching elements the in graphical representation is another way to present the query result. The result can also be fed to other post-processing steps or further used by a caller of the query. Queries can be named and stored/saved persistency for later re-use.

Examples of queries for use on a systems model are:
a) Locate systems reachable from outside network
b) Locate systems that are tagged “finance”
c) Find systems that are using a certain storage
d) Find systems routed through a certain network switch
e) Find systems with more than one backup
f) Locate all systems that have utilization level above 20% that share resources.

### Scenario 4

### Using Queries to Find Problems and Root-Causes

This scenario describes a system where queries are used to find current problems, potential problems, performance bottlenecks and possibly their root-cause so the systems model.

Queries in this scenarios are defined in the same way as in Scenario 3 with the difference that in this case the queries are defined to locate CIs in the systems model that are part of constellations that indicates problems in current configuration data. In big environments there exist problems that are very hard to find when inspecting individual management systems but these problems can be found when running queries on a systems model holding a unified view populated from the individual management systems. Certain problems and warnings can also be dependent on the business context which the CIs are in and this can be taken in account in the query by including matching for manually added tags and Dynamic Tag results. The query result can be presented in similar ways as described in Scenario 3.

Examples of problem-finding queries are:
a) Locate items that are tagged “warning”
b) Locate systems that are both tagged “critical” and are offline.
c) Locate systems depending on a failed storage
d) Locate network switches that will affect systems tagged “critical” if they fail.
e) Locate systems tagged “finance” that uses storage tagged “low-reliability”
f) Find systems that are in the same IP range but are tagged with different “owner”-tags.
g) Find if a set of systems with warning indication uses any shared resource that is degraded or failing.

### Scenario 5

### Automatic Policy/Criteria Evaluations Using Queries

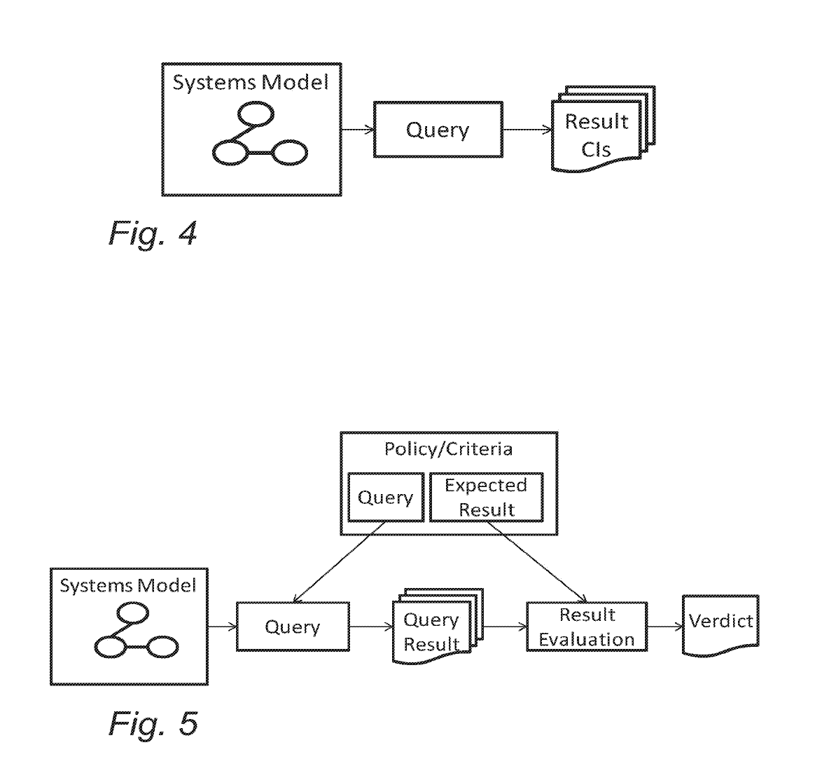

This scenario describes a system, as in FIGS. 4 and 5, where criteria/policies are described as evaluations using queries and their expected results. Many environments have more or less policies specified regarding how systems should be configured and connected to each other. That these policies are enforced can be verified by going through each related configure point and check that it is set with values that are allowed by the policy. Checking configurations is a time-consuming work to do manually and the amount of checks to carry out increases both with amount of policies and amount of systems in the environment. For every systems policy/criteria that can be answered with direct or indirect information found in the systems model there can be defined a query and expected result pair that evaluates each criteria. The query is responsible for returning information that a specific policy is to inspect. The query result is matched with the expected result and if matching that specific policy/criteria is said to be valid. The expected result can be specified in amount of matched CIs the query matched but also other matching criteria if using a query that returns of result type.

Examples of policies translated to queries and their expected result are:
a) Query: Find systems without secondary network connection and labelled “production”.
   Expected result: zero matches
b) Query: Find all “owner”-tags associated with systems using storage tagged “private”.
   Expected result: one or zero results
c) Query: Find all systems tagged “internal” reachable from external network.
   Expected result: zero matches
d) Query: Find all systems reachable from both internal and external network.
   Expected result: one match
e) Query: Find all systems with more than one backup.
   Expected result: zero matches

Matching query results and expected results indicate that criterion is valid and can result can be notified to operator, stored in log and/or generate event indicating valid criterion/policy. Non-matching query results indicate that criterion is not met and error/warning result can be notified to operator immediately, logged, generating event indicating failure and/or directly trigger actions. Events can also be distributed to other management systems for further handling.

Multiple pairs of query and expected result can be bundled together to form a set of policies/criteria that can be imported to and exported from the system and distributed as named policy sets.

An optional severity rating of the query and expected result pair can influence the result handling of success/failure evaluations.

Examples of query and expected result pair ratings and associated handling are:
a) Only query-result pairs rated “critical” will notify operator directly.
b) Query-result pairs rated “warning” will only generate a log and an event if result is failure.
c) Query-result pairs rated “debug” will only generate a log in any result case.

Further can evaluations that failed report the CIs invoked in the query to be used for indicating which items in the systems model that is related to the failed policy/criteria.

1. A computerized method for tagging information in a virtual server environment based on a systems model of a managed system, comprising
providing configuration date for tags, the tags being associated with configurable items of the systems model in the virtual server environment,
evaluating data in the virtual server environment based on a set of predetermined evaluation rules and the provided configuration data, and
generating a new tag, removing an existing tag, or updating an existing tag based on the evaluation.

2. The method according to claim 1, wherein the generating is performed in response to receiving user input relating to meta-data of the tag.

3. The method according to claim 1, wherein each tag has a value, and wherein the value is derived from at least one from the group of configuration data, manually added tags, and/or computed tags.

4. The method according to claim 1, further comprising
performing an action based on the tags and based on a set of predetermined action rules.

5. The method according to claim 4, further comprising
updating the systems model based on the action.

6. The method according to claim 5, wherein the systems model relates to at least one managed virtual and/or physical server, the method further comprising
transmitting provisioning and/or modifications from the systems model to the managed system based on the updated systems model, thereby causing changes to the at least one managed virtual and/or physical server.

7. The method according to claim 1, wherein the step of evaluating is triggered as a result of an event occurred in the managed system.

8. The method according to claim 1, wherein the step of evaluating is continuously performed during operation of the systems model.

9. The method according to claim 1, wherein the configuration data is received by the systems model from the managed system.

10. The method according to claim 1, further comprising
executing at least one query, thereby finding items matching the configuration data and/or combinations of associated manual and dynamic tags.

11. The method according to claim 7, further comprising
transmitting a result of the query to a user interface as a report and/or log.

12. A computer program product stored on a non-volatile storage medium and comprising software instructions that when executed on a processor causes the processor to perform a method according to claim 1.

13. A system for tagging information in a virtual server environment based on a systems model, comprising
a systems model arranged to provide configuration data for tags, the tags being associated with configurable items of the systems model in the virtual server environment,
an evaluation rules engine arranged to
evaluate data in the virtual server environment based on a set of predetermined evaluation rules and the provided configuration data, and to
generate a new tag, remove an existing tag, or update an existing tag based on the evaluation.

14. The system according to claim 13, further comprising
an action rules engine arranged to perform an action based on the tags and based on a set of predetermined action rules

15. The system according to claim 14, wherein the managed system relates to at least one managed virtual and/or physical server, wherein
the systems model is further arranged to transmit provisioning and/or modifications to the managed system based on an updated systems model, and wherein the systems model thereby is arranged to cause changes to the at least one managed virtual and/or physical server.
